(19) United States
(12) Patent Application Publication
(10) Pub. No.: US 2013/0194691 A1
(43) Pub. Date: Aug. 1, 2013

(54) MAGNETIC DISK DRIVE AND METHOD FOR CONTROLLING THE SAME

(71) Applicants: Takeshi Hara, Tokyo (JP); Kazuhiko Takaishi, Tokyo (JP)

(72) Inventors: Takeshi Hara, Tokyo (JP); Kazuhiko Takaishi, Tokyo (JP)

(73) Assignee: Kabushiki Kaisha Toshiba, Tokyo (JP)

(21) Appl. No.: 13/472,238

(22) Filed: May 15, 2012

(30) Foreign Application Priority Data
Jan. 31, 2012 (JP) 2012-018959

(51) Int. Cl. G11B 21/02; G11B 20/00

(52) U.S. Cl. 360/39; 360/75; 360/70; G9B/21.003; G9B/20

(57) ABSTRACT

According to one embodiment, there is provided a magnetic disk device including an acceleration feedforward module, an eccentricity correction module, and a control module. The acceleration feedforward module includes a first amplification module, a second amplification module, and an addition module. The first amplification module amplify a first rotation correlation value according to a rotation component by a first gain. The second amplification module amplifies a second rotation correlation value according to a rotation synchronization component of the rotation component, by a second gain acquired by subtracting the first gain from 1. The addition module adds the first rotation correlation value amplified by the first amplification module and the second rotation correlation value amplified by the second amplification module to obtain the first correction amount.

### CROSS-REFERENCE TO RELATED APPLICATIONS

This application is based upon and claims the benefit of priority from Japanese Patent Application No. 2012-018959, filed on Jan. 31, 2012; the entire contents of which are incorporated herein by reference.

### FIELD

Embodiments described herein relate generally to a magnetic disk device and a method for controlling the magnetic disk device.

### BACKGROUND

In a magnetic disk device, it is essential to precisely position a magnetic head in a target position (target track) in the magnetic disk to improve record density. Recently, with high TPI (Track Per Inch), improvement in the positioning accuracy of a magnetic head is desired compared to the related art.

### BRIEF DESCRIPTION OF THE DRAWINGS

FIG. 1 is a diagram illustrating configuration of a magnetic disk device according to a first embodiment;

FIG. 2 is a diagram illustrating an operation of an acceleration feedforward module according to the first embodiment;

FIGS. 3A and 3B are diagrams illustrating an operation of the acceleration feedforward module according to the first embodiment;

FIG. 4 is a flowchart illustrating an operation of the acceleration feedforward module according to the first embodiment;

FIG. 5 is a diagram illustrating an operation of the magnetic disk device according to the first embodiment;

FIG. 6 is a flowchart illustrating an operation of an acceleration feedforward module according to a modified example of the first embodiment;

FIG. 7 is a diagram illustrating a configuration of an acceleration feedforward module according to a second embodiment;

FIG. 8 is a diagram illustrating a configuration of an acceleration feedforward module according to a third embodiment;

FIG. 9 is a diagram illustrating a configuration of an acceleration feedforward module according to a fourth embodiment;

FIG. 10 is a diagram illustrating a configuration of an acceleration feedforward module according to a fifth embodiment;

FIG. 11 is a diagram illustrating a configuration of an acceleration feedforward module according to a sixth embodiment;

FIG. 12 is a diagram illustrating a configuration of an acceleration feedforward module according to a seventh embodiment;

FIG. 13 is a diagram illustrating a comparison example; and

FIG. 14 is a diagram illustrating a comparison example.

### DETAILED DESCRIPTION

In general, according to one embodiment, there is provided a magnetic disk device including an acceleration feedforward module, an eccentricity correction module, and a control module. The acceleration feedforward module obtains a first correction amount to correct a rotation vibration of a case, based on a rotation component of an acceleration acting on the case. The eccentricity correction module obtains a second correction amount to perform an eccentricity correction of a magnetic disk, based on a position of a magnetic head with respect to the magnetic disk. The control module performs control to determine a position of the magnetic head using the first correction amount and the second correction amount. The acceleration feedforward module includes a first amplification module, a second amplification module, and an addition module. The first amplification module amplifies a first rotation correlation value according to the rotation component by a first gain. The second amplification module amplifies a second rotation correlation value according to a rotation synchronization component of the rotation component, by a second gain acquired by subtracting the first gain from 1. The addition module adds the first rotation correlation value amplified by the first amplification module and the second rotation correlation value amplified by the second amplification module to obtain the first correction amount.

Exemplary embodiments of a magnetic disk device and a method for controlling the magnetic disk device will be explained below in detail with reference to the accompanying drawings. The present invention is not limited to the following embodiments.

### First Embodiment

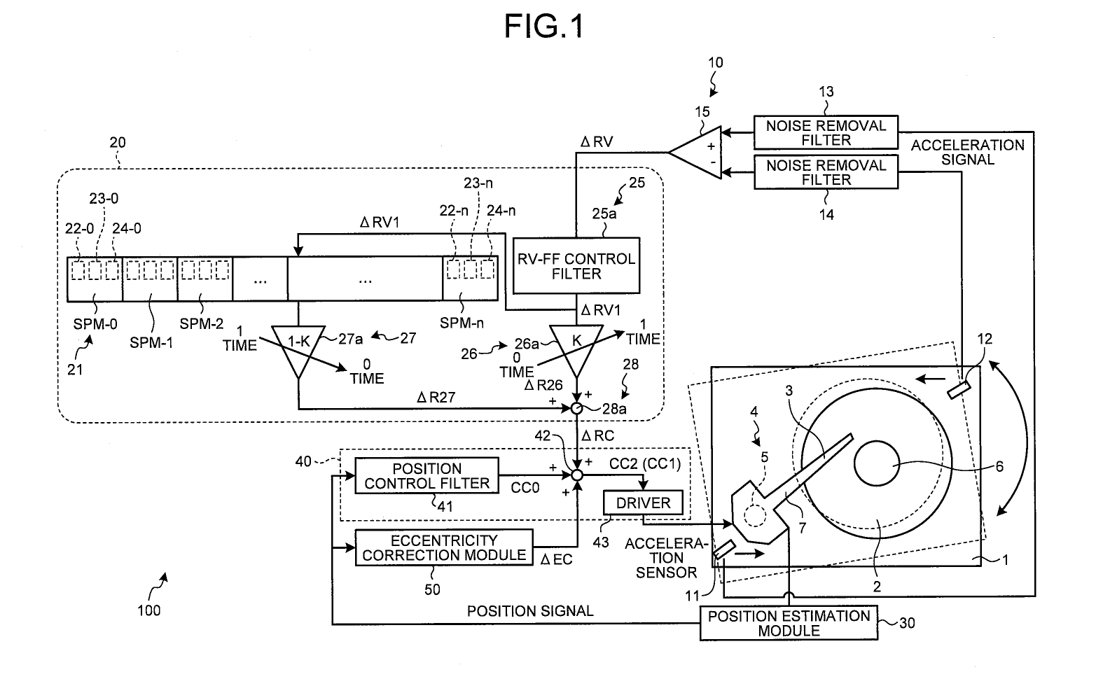

An appearance configuration of a magnetic disk device 100 according to the first embodiment will be explained with reference to FIG. 1. FIG. 1 is a diagram illustrating a configuration of the magnetic disk device 100.

The magnetic disk device 100 has a case 1, a magnetic disk 2, a magnetic head 3, an actuator 4, a spindle motor 6, an arm 7, a position estimation module 30, a position control module 40, an eccentricity correction module 50, an acquisition module 10 and an acceleration feedforward module 20.

In the case 1, the magnetic disk 2 is rotatably mounted via the spindle motor 6. The magnetic disk 2 is a disc-shaped recording medium to record various kinds of information and is rotationally driven by the spindle motor 6. The magnetic disk 2 has, for example, a vertical recording layer having anisotropy in the vertical direction with respect to a surface.

Also, in the case 1, the magnetic head 3 and the arm 7 are mounted to be able to be driven via the actuator 4 including a voice coil motor 5. The reading and writing operations for the magnetic disk 2 are performed by the magnetic head 3 provided in one end of the arm 7 that is a head support construction. While maintaining a state of slightly floating on the surface of the magnetic disk 2 by the lift power caused by rotation of the magnetic disk 2, the magnetic head 3 records information in the magnetic disk 2 and reads and reproduces information recorded in the magnetic disk 2. Also, by driving of the actuator 4 including the voice coil motor 5 provided on the other end of the arm 7, the arm 7 moves along the arc with the center being the axis of the voice coil motor 5 and the magnetic head 3 seek-moves in the track transverse direction of the magnetic disk 2 and changes a reading/writing target track.

At this time, the magnetic head 3 reads servo information (see FIGS. 3A and 3B) that is periodically provided on the surface of the magnetic disk 2 along the rotation direction of the magnetic disk 2 and outputs the read servo information to the position estimation module 30. The position estimation module 30 estimates a position of the magnetic head 3 with respect to the magnetic disk 2, from the servo information, and outputs a position signal based on the estimation result.

The position control module 40 receives the position signal output from the position estimation module 30 and, based on this position signal, controls the actuator 4 to determine a position of the magnetic head 3 with respect to the magnetic disk 2.

At this time, if there is a fine gap (eccentricity) between the axis center of the spindle motor 6 and the rotation center of the magnetic disk 2, there is a possibility that this eccentricity degrades the accuracy of position determination by the position control module 40. Therefore, the eccentricity correction module 50 receives the position signal output from the position estimation module 30 and, based on this position signal, obtains eccentricity correction amount ΔEC to perform eccentricity correction of the magnetic disk. For example, the eccentricity correction module 50 extracts rotation synchronization component RRO from the position signal, obtains the eccentricity amount between the axis center of the spindle motor 6 and the rotation center of the magnetic disk 2 from the extracted rotation synchronization component RRO, and obtains the eccentricity correction amount ΔEC to cancel out the obtained eccentricity amount. The eccentricity correction module 50 supplies the eccentricity correction amount ΔEC to the position control module 40.

In response to this, the position control module 40 uses the eccentricity correction amount ΔEC to determine a position of the magnetic head 3 so as to cancel out the eccentricity amount. To be more specific, the position control module 40 has a position control filter 41, an adder 42 and a driver 43. The position control filter 41 receives the position signal output from the position estimation module 30 and, for example, determines control current CC0 to be supplied to the driver 43 and supplies it to the adder 42 such that the magnetic head 3 approaches a target position based on the position signal. For example, the position control filter 41 may extract rotation asynchronous component NRRO from the position signal and determine the control current CC0 so as to cancel out the extracted rotation asynchronous component NRRO. The adder 42 receives the control current CC0 from the position control filter 41 and receives the eccentricity correction amount ΔEC from the eccentricity correction module 50. For example, the adder 42 adds the eccentricity correction amount ΔEC to the control current CC0 and supplies the addition result to the driver 43 as control current CC1. The driver 43 drives the actuator 4 according to the control current CC1.

Meanwhile, a fan and a different magnetic disk device (not shown) are arranged near the magnetic disk device 100. According to their driving, the fan and the different magnetic device may give a rotation vibration to the magnetic disk device 100 as illustrated by dash line in FIG. 1. Such a rotation vibration of the case 1 causes a relative position gap between the magnetic disk 2 and the magnetic head 3, and therefore the accuracy of position determination by the position control module 40 may be degraded. Therefore, the acquisition module 10 acquires the rotation component of acceleration acting on the case 1, and, based on the rotation component of acceleration acting obtains vibration correction amount ΔRC to correct the rotation vibration of the case 1.

To be more specific, the acquisition module 10 has a plurality of acceleration sensors 11 and 12, a plurality of noise removal filters 13 and 14, and a differentiator 15. The plurality of acceleration sensors 11 and 12 is fixed in different positions in the case 1. For example, the plurality of acceleration sensors 11 and 12 is arranged on opposite sides with respect to the magnetic disk 2. The plurality of acceleration sensors 11 and 12 detects acceleration acting on the case 1 and supplies the detection results to the corresponding noise removal filters 13 and 14 as acceleration signals. The plurality of noise removal filters 13 and 14 removes radio frequency noise from the received acceleration signals, respectively, and supplies the acceleration signals after removal of the radio frequency noise to the differentiator 15. The differentiator 15 obtains the difference between the signals received from the plurality of noise removal filters 13 and 14. That is, the differentiator 15 obtains difference ΔRV between the accelerations detected in the plurality of acceleration sensors 11 and 12 as the rotation component of acceleration acting on the case 1, and supplies the difference to the acceleration feedforward module 20.

The acceleration feedforward (RV-FF) module 20 receives the rotation component ΔRV of acceleration acting on the case 1 from the acquisition module 10. Based on this rotation component ΔRV of the accelerations, the acceleration feedforward module 20 obtains the vibration correction amount ΔRC to correct the rotation vibration of the case 1. For example, the acceleration feedforward module 20 obtains the vibration correction amount ΔRC so as to cancel out the rotation component ΔRV of the accelerations. That is, the acceleration feedforward module 20 supplies the obtained vibration correction amount ΔRC to the position control module 40 to correct the rotation vibration of the case 1 at acceleration level (the potential position gap level) before the rotation vibration of the case 1 appears as a relative position gap between the magnetic disk 2 and the magnetic head 3.

In response to this, the position control module 40 determines a position of the magnetic head 3 not only to cancel out the eccentricity amount using the eccentricity correction amount ΔEC but also to suppress the rotation vibration of the case 1 using the vibration correction amount ΔRC. To be more specific, the adder 42 receives the control current CC0 from the position control filter 41, receives the eccentricity correction amount ΔEC from the eccentricity correction module 50 and receives the vibration correction amount ΔRC from the acceleration feedforward module 20. For example, the adder 42 adds the eccentricity correction amount ΔEC and the vibration correction amount ΔRC to the control current CC0 and supplies the addition result to the driver 43 as control current CC2. The driver 43 drives the actuator 4 according to the control current CC2.

Thus, the magnetic disk device 100 has the acceleration feedforward module 20 to suppress the rotation vibration of the case 1 and the eccentricity correction module 50 to correct rotation synchronization component RRO of the position signal.

Eccentricity correction processing in the eccentricity correction module 50 denotes, for example, processing of extracting the rotation synchronization component RRO from the position signal and feeding it back to the control current CC2. An occurrence of the rotation synchronization component RRO is caused by, for example; the rotation asynchronous/synchronization components at the time of the writing of servo information; a difference between the servo information writing center and the device rotation center; a phase switching during current control of the spindle motor 6; and a rotation vibration of the case caused by rotation of the spindle motor 6. The rotation synchronization component RRO is much greater than rotation asynchronous component NRRO, and there are various kinds of correction methods specialized to suppress the rotation synchronization component RRO.

Acceleration feedforward (RV-FF) processing in the acceleration feedforward module 20 denotes processing of obtaining a vibration (acceleration) and feeding forward it to the control current CC2. Compared to a case where the eccentricity correction processing in the eccentricity correction module 50 obtains a position signal subjected to two integrations from an acceleration and feeds back it to the control current, the acceleration feedforward processing in the acceleration feedforward module 20 enables correction at acceleration level and therefore provides good responsivity. Also, there is a difference for a correction target, that is, while the acceleration feedforward processing targets a rotation synchronization/asynchronous vibration, the eccentricity correction processing targets a rotation synchronization position signal.

Here, if the acceleration feedforward processing is always operated, in a case where the rotation vibration of the case 1 is not provided or is small to be negligible, a noise influence of the acceleration sensors 11 and 12 is given, and therefore the accuracy of position determination by the position control module 40 may be conversely degraded.

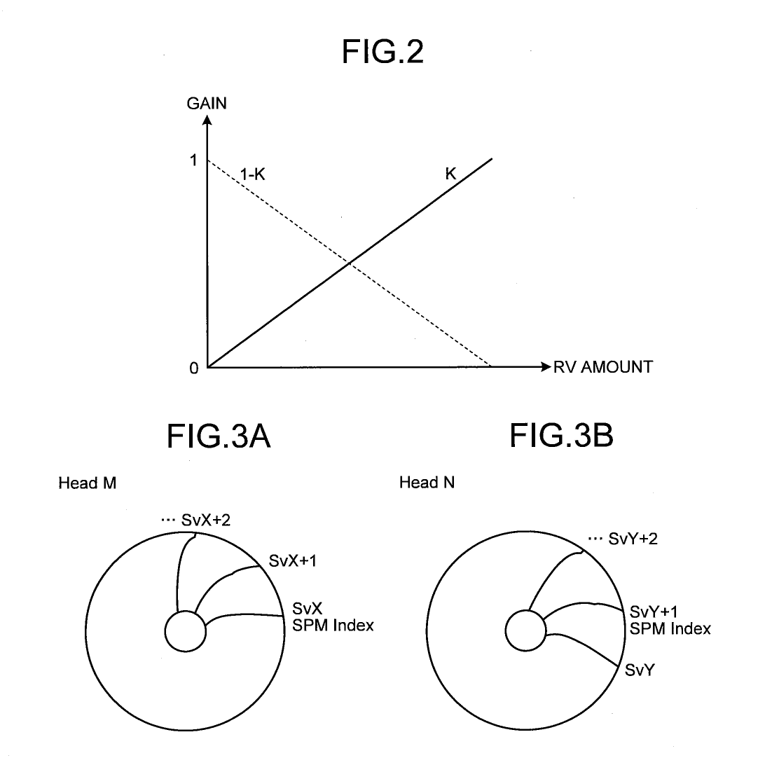

Therefore, in a case where it is determined that the rotation vibration of the case 1 is not provided or is small to be negligible, an external controller (not shown) cancels the acceleration feedforward processing (gain K=0) or applies gain K (0<K<1) to the vibration correction amount ΔRC by the acceleration feedforward processing to make it small (see FIG. 2). Instead, the rotation vibration of the case 1 appears as a relative position gap between the magnetic disk 2 and the magnetic head 3, the rotation synchronization component RRO is corrected by the eccentricity correction module 50 and the rotation asynchronous component NRRO is corrected by the position control filter 41. In this method, depending on the magnitude relationships between noise of the acceleration sensors 11 and 12 and an actual vibration, the external controller needs to often switch a subject for correction processing of the rotation vibration of the case 1 between the acceleration feedforward module 20, the eccentricity correction module 50 and the position control filter 41.

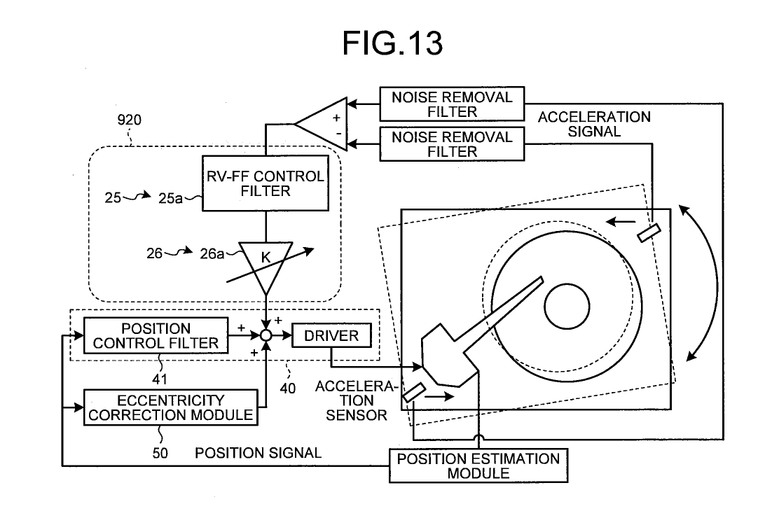

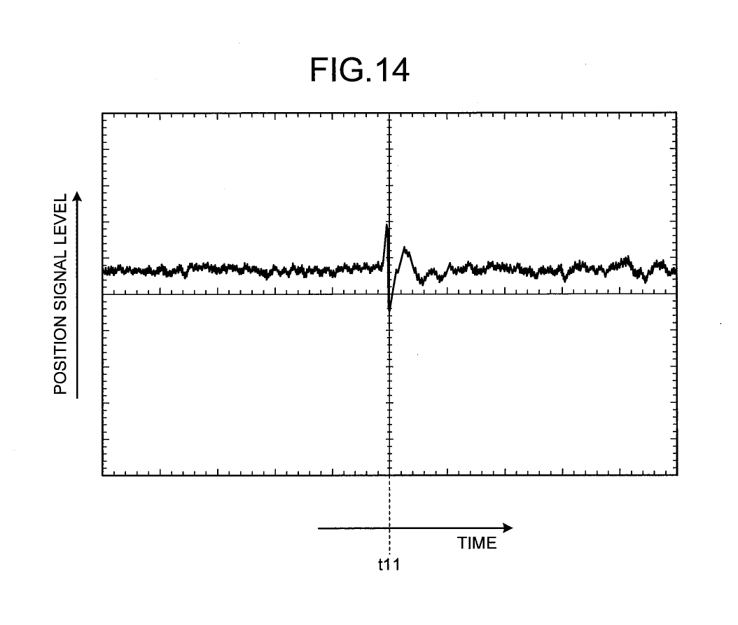

Here, as shown in FIG. 13, assume a case where an acceleration feedforward module 920 has a third amplification module 25 and a first amplification module 26. In this case, a transient response may occur at the time of switching acceleration feedforward processing by the acceleration feedforward module 920 and processing by the eccentricity correction module 50 and the position control filter 41. For example, as shown in FIG. 14, there is a tendency that hunting occurs in the position signal level at timing t11 when the acceleration feedforward processing by the acceleration feedforward module 920 is switched to the processing by the eccentricity correction module 50 and the position control filter 41. A possible countermeasure for this includes a method of gradually switching the gain of the acceleration feedforward processing under control by the external controller; however, in this method, the waiting time for switching becomes long, and therefore it is difficult to often perform the above-mentioned switching.

According to the present inventor's study, it is obtained that a dominant factor of the transient response is an inner rotation vibration of the case 1 caused by rotation of the spindle motor 6. That is, in a case where the acceleration feedforward processing is valid (gain K=1), the rotation vibration of the case 1 can be corrected as acceleration feedforward processing, and, in a case where the acceleration feedforward processing is invalid (K=0) or the gain is weakened (0<K<1), the rotation vibration is regarded as the rotation synchronization component RRO of the position gap and therefore can be corrected as eccentricity correction. Therefore, if the acceleration feedforward processing is validated/invalidated or the gain of the acceleration feedforward processing is changed, since the eccentricity correction provides a poor responsivity, there seems to be a tendency that a temporary lack of correction or an excess correction state occurs.

Therefore, to overcome the transient response state, the present embodiment suggests that the rotation vibration of the case 1 by rotation of the spindle motor 6 is always fed forward regardless of the gain switching of acceleration feedforward processing. There are rotation synchronization component RRO synchronized with the rotation period of the spindle motor 6 and rotation synchronization component RRO synchronized with servo information written in the magnetic disk 2. In the latter, there is a case where its position varies depending on a magnetic head (see FIGS. 3A and 3B). The rotation vibration of the case 1 by rotation of the spindle motor 6 corresponds to the former. Generally, since eccentricity correction is controlled using a servo, the correction is performed by servo information synchronization, that is, the correction is performed without distinguishing those.

Taking into account this point, according to the present embodiment, by adding a loop (extraction module 21 and second amplification module 27) that feeds forward the rotation synchronization vibration component of rotation vibration of the case to the acceleration feedforward module 20, that is, by adding a block to learn feedforward current synchronized with rotation and applying it to supplement a suppression gain change in acceleration feedforward processing, a position signal change by the rotation vibration of the case synchronized with the rotation is suppressed not to provide the rotation synchronization component RRO. By this means, it is suggested that, at the time of switching between the acceleration feedforward processing in the acceleration feedforward module 20 and the processing in the eccentricity correction module 50 and the position control filter 41, correction of the former by the acceleration feedforward processing is not weakened but is maintained.

To be more specific, as shown in FIG. 1, the acceleration feedforward module 20 has the third amplification module 25, the extraction module 21, the first amplification module 26, the second amplification module 27 and an addition module 28.

The third amplification module 25 obtains a correction amount (feedforward current) to be added to the control current CC0, from the rotation component ΔRV acquired in the acquisition module 10. For example, the third amplification module 25 has a control filter 25a, amplifies the rotation component ΔRV by gain G so as to cancel out the rotation component ΔRV, and outputs amplified rotation component ΔRV1 (value based on the rotation component ΔRV or the first rotation correlation value) to the first amplification module 26 and the extraction module 21.

The extraction module 21 extracts the rotation synchronization component RRO from the value based on the rotation component ΔRV acquired in the acquisition module 10, that is, from the amplified rotation component ΔRV1. The extraction module 21 learns a component synchronized with rotation of the spindle motor 6. That is, the extraction module 21 obtains a component synchronized with a rotation signal of the spindle motor 6 from the amplified rotation component ΔRV1, learns the obtained component and extracts the rotation synchronization component RRO.

For example, to learn the component synchronized with rotation of the spindle motor 6, by using a counter synchronized with a rotation signal of the spindle motor 6, an average value is obtained for every counter value and provided as an output value. That is, the extraction module 21 averages value ΔRV1 according to a plurality of rotation components acquired over a plurality of times in the acquisition module 10, and extracts the rotation synchronization components RRO. Here, after that, gain 1−K (second gain) is applied. By this means, it is possible to cover up to a higher-order component (e.g. Nyquist frequency).

Here, for a rotation signal (SPM index) of the spindle motor 6, a servo frame number of servo information varies depending on the head (see FIGS. 3A and 3B). In eccentricity correction, applied current is calculated from the servo frame number. Meanwhile, internal vibration by rotation of the spindle motor 6 is synchronized with the rotation period of the spindle motor 6. This is synchronized with the phase switching of the spindle motor 6. Therefore, other counters than a counter for eccentricity correction are prepared, and correction is performed using counters 22-0 to 22-n to count up the number for every servo frame synchronized with rotation signals SPM-0 to SPM-n of the spindle motor 6.

For example, the extraction module 21 has blocks SPM-0 to SPM-n corresponding to multiple rotation signals SPM-0 SPM-n of the spindle motor 6. That is, the extraction module 21 has multiple counters 22-0 to 22-n, multiple computation modules 23-0 to 23-n and multiple storage modules 24-0 to 24-n. The multiple counters 22-0 to 22-n correspond to the multiple rotation signals SPM-0 to SPM-n of the spindle motor 6. The counters 22-0 to 22-n each performs count operations in synchronization with the corresponding rotation signals SPM-0 to SPM-n of the spindle motor 6 for the amplified rotation component ΔRV1.

By averaging the count values of the corresponding counters 22-0 to 22-n, the computation modules 23-0 to 23-n obtain rotation synchronization components RRO-0 to RRO-n excluding rotation asynchronous component NRRO. That is, the computation modules 23-0 to 23-n obtain the average values of count values of the corresponding counters 22-0 to 22-n as the rotation synchronization components RRO-0 to RRO-n. The storage modules 24-0 to 24-n store the rotation synchronization components RRO-0 to RRO-n obtained by the corresponding computation modules 23-0 to 23-n.

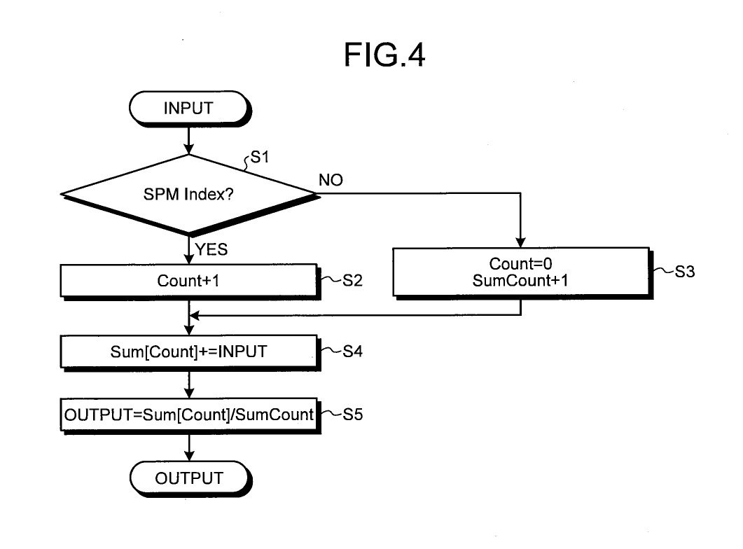

For example, as shown in FIG. 4, the counters 22-0 to 22-n each refer to a rotation signal (SPM index) of the spindle motor 6 and determine whether the current rotation signal is a rotation signal corresponding to the own counter (step S1). If the counters 22-0 to 22-n each determine that the rotation signal corresponds to the own counter (“Y” in step S1), count value “Count” is incremented (step S2), and, if they determine that the rotation signal does not correspond to the own counter (“N” in step S1), the count value “Count” is not incremented and sum count value “SumCount” is incremented (step S3). Then, the computation modules 23-0 to 23-n each additionally input the count value “Count” to sum value “Sum[Count]” (step S4) and obtain an average value by dividing the sum value “Sum[Count]” by the sum count value “SumCount” (step S5).

Here, if the multiple computation modules 23-0 to 23-n can separately perform computations for the multiple rotation signals SPM-0 to SPM-n of the spindle motor 6, the multiple counters 22-0 to 22-n may be shared. Also, if the multiple storage modules 24-0 to 24-n can separately store the multiple rotation signals SPM-0 to SPM-n of the spindle motor 6, the multiple counters 22-0 to 22-n may be shared.

Also, for example, the external controller may receive the rotation component ΔRV of acceleration acting on the case 1 from the acquisition module 10. Also, the external controller may have control information as shown in FIG. 2. In the control information shown in FIG. 2, it is determined in advance for each value of the rotation component ΔRV (RV amount) that a sum of first gain K of the first amplification module 26 and second gain 1−K of the second amplification module 27 is 1. For example, if the external controller receives the acceleration rotation component ΔRV from the acquisition module 10, the external controller refers to the control information shown in FIG. 2, determines the first gain K and the second gain 1−K corresponding to a value of the received rotation component ΔRV (RV amount) and supplies a control signal based on the determination result to the first amplification module 26 and the amplification module 27.

The first amplification module 26 receives the amplified rotation component ΔRV1 from the third amplification module 25. For example, the first amplification module 26 has a variable gain amplifier 26a in which the first gain K is set, and amplifies the amplified rotation component ΔRV1 (first rotation correlation value) by the first gain K. The first gain K is a value between 0 and 1. For example, the first amplification module 26 receives a control signal from the external controller, changes the first gain K based on the control signal and amplifies the amplified rotation component ΔRV1 by the changed first gain K.

For example, regarding the amplified rotation component ΔRV1, when a value corresponding to the rotation signal SPM-0 of the spindle motor 6 is ΔRV1-0, rotation component ΔRV1-0 includes rotation synchronization component RRO-0 and rotation asynchronous component NRRO-0. Therefore, when a result of amplification by the first amplification module 26 (amplified first rotation correlation value) is ΔRV26-0, following Equation 1 is established.

ΔRV26-0=K×(RRO-0)+K×(NRRO-0) (Equation 1)

The same applies to values corresponding to other rotation signals SPM-1 to SPM-n of the spindle motor 6. The first amplification module 26 supplies the amplified first rotation correlation value ΔRV26 to the addition module 28.

For example, the second amplification module 27 reads rotation synchronization components RRO-0 to RRO-n from the corresponding storage modules 24-0 to 24-n, according to the rotation signals SPM-0 to SPM-n of the spindle motor 6. For example, the second amplification module 27 has a variable gain amplifier 27a in which the second gain 1−K is set, and amplifies the rotation synchronization components RRO-0 to RRO-n (second rotation correlation values) by the second gain 1−K. The second gain 1−K is acquired by subtracting the first gain K from 1. For example, the second amplification module 27 receives a control signal from the external controller, changes the second gain 1−K according to the control signal and amplifies the rotational synchronization components RRO-0 to RRO-n by the changed second gain 1−K.

For example, as a value corresponding to the rotation signal SPM-0 of the spindle motor 6, when a result of amplification by the second amplification module 27 (amplified second rotation correlation value) is ΔRV27-0, following Equation 2 is established.

ΔRV27-0=(1−K)×(RRO-0) (Equation 2)

The same applies to values corresponding to other rotation signals SPM-1 to SPM-n of the spindle motor 6. The second amplification module 27 supplies the amplified second rotation correlation value ΔRV27 to the addition module 28.

The addition module 28 receives the amplified first rotation correlation value ΔRV26 from the first amplification module 26 and receives the amplified second rotation correlation value ΔRV27 from the second amplification module 27. For example, the addition module 28 has an adder 28a, and adds the amplified first rotation correlation value ΔRV26 and the amplified second rotation correlation value ΔRV27 using the adder 28a to obtain vibration correction amount ΔRC.

For example, as a value corresponding to the rotation signal SPM-0 of the spindle motor 6, when the vibration correction amount obtained by the addition module 28 is ΔRC-0, following Equation 3 is established according to Equation 1 and Equation 2.

ΔRC-0=(ΔRV26-0)+(ΔRV27-0)=K×(RRO-0)+K×(NRRO-0)+(1−K)×(RRO-0)=1×(RRO-0)+K×(NRRO-0) (Equation 3)

The same applies to values corresponding to other rotation signals SPM-1 to SPM-n of the spindle motor 6. The addition module 28 supplies the vibration correction amount ΔRC to the adder 42 of the position control module 40.

As shown in Equation 3, even in a case where: it is determined that the rotation vibration of the case 1 is not provided or is small to be negligible; switching is performed from the acceleration feedforward processing by the acceleration feedforward module 20 to the processing by the eccentricity correction module 50 and the position control filter 41; and the acceleration feedforward processing is invalid (K=0) or the gain is weakened (0<K<1) (see FIG. 2), it is possible to maintain correction of rotation synchronization component (RRO-0) by the acceleration feedforward processing without weakening the correction and weaken rotation asynchronous component (NRRO-0) such as noise of the acceleration sensors 11 and 12.

As described above, according to the first embodiment, in the acceleration feedforward module 20, the first amplification module 26 amplifies the first rotation correlation value ΔRV1 (=RRO+NRRO) according to the rotation component ΔRV of acceleration acting on the case 1, by the first gain K. The second amplification module 27 amplifies the second rotation correlation value RRO according to the rotation synchronization component of the rotation component ΔRV of acceleration acting on the case 1, by the second gain 1−K acquired by subtracting the first gain “K” from 1. That is, it is set that a sum of the first gain K and the second gain 1−K is 1 (see FIG. 2). The addition module 28 adds first rotation correlation value K×(RRO+NRRO) amplified by the first amplification module 26 and second rotation correlation value (1−K)×RRO amplified by the second amplification module 27 to obtain vibration correction amount ΔRC (=1×RRO+K×NRRO).

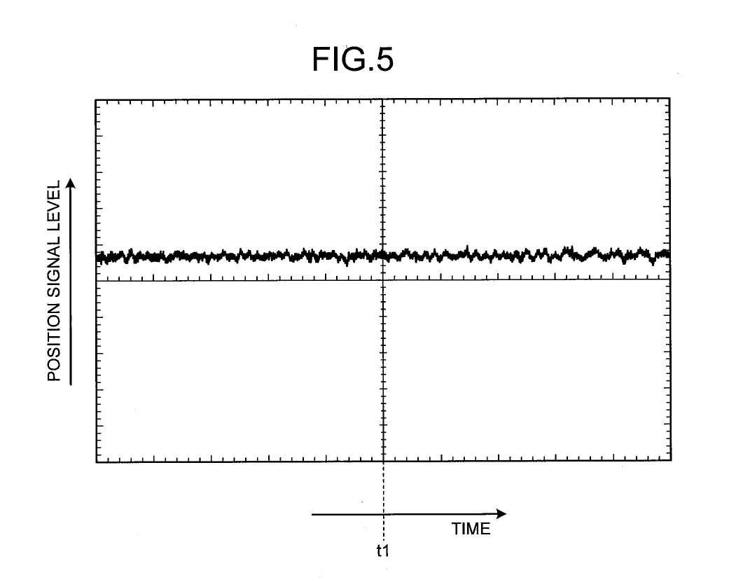

By this means, even in a case where: it is determined that the rotation vibration of the case 1 is not provided or is small to be negligible; switching is performed from the acceleration feedforward processing by the acceleration feedforward module 20 to the processing by the eccentricity correction module 50 and the position control filter 41; and the acceleration feedforward processing is invalid (K=0) or the gain is weakened (0<K<1), it is possible to maintain correction of the rotation synchronization component RRO by the acceleration feedforward processing without weakening the correction and weaken the rotation asynchronous component NRRO such as noise of the acceleration sensors 11 and 12. That is, it is possible to suppress a transient response of the rotation synchronization component RRO at the time of switching suppression gain K (ON/OFF) of acceleration feedforward processing. For example, as shown in FIG. 5, at timing t1 at which the acceleration feedforward processing by the acceleration feedforward module 20 is switched to the processing by the eccentricity correction module 50 and the position control filter 41, hunting in the position signal level is suppressed. By this means, even if acceleration feedforward is often switched, it is possible not to cause performance degradation. In other words, in the case of switching between the acceleration feedforward processing by the acceleration feedforward module 20 and the processing by the eccentricity correction module 50 and the position control filter 41, it is possible to suppress a transient response and improve the accuracy in determining the position of the magnetic head 2.

Also, according to the first embodiment, the extraction module 21 averages the value ΔRV1 according to a plurality of rotation components acquired over a plurality of times by the acquisition module 10, and extracts rotation synchronization components. By this means, it is possible to remove the rotation asynchronous components and extract the rotation synchronization components by simple processing.

Also, according to the first embodiment, the extraction module 21 obtains components synchronized with the rotation signals SPM-0 to SPM-n of the spindle motor 6 from the value ΔRV1 according to the rotation components acquired by the acquisition module 10, learns the obtained components and extracts the rotation synchronization components. By this means, it is possible to extract the rotation synchronization components in consideration of characteristic differences between each rotation signal from SPM-0 to SPM-n of the spindle motor 6.

Also, according to the first embodiment, the multiple counters 22-0 to 22-n perform count operations on the value ΔRV1 according to rotation components in synchronization with the multiple rotation signals SPM-0 to SPM-n of the spindle motor 6. The computation modules 23-0 to 23-n obtain the average values of count values of each of the multiple counters 22-0 to 22-n as the rotation synchronization components RRO-0 to RRO-n. The storage modules 24-0 to 24-n store the rotation synchronization components RRO-0 to RRO-n of each of the multiple counters 22-0 to 22-n obtained by the multiple computation modules 23-0 to 23-n. By this means, it is possible to learn the rotation synchronization components RRO-0 to RRO-n for each of the rotation signals SPM-0 to SPM-n of the spindle motor 6.

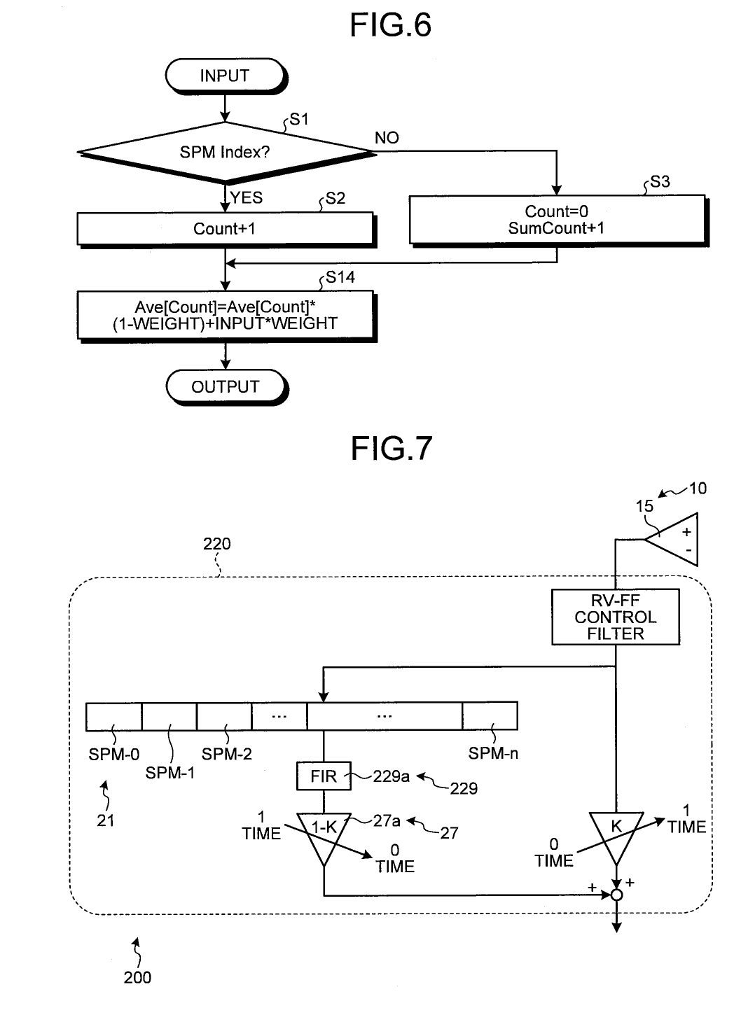

Here, learning by the extraction module 21 may be performed by the moving average. For example, as shown in FIG. 6, the extraction module 21 may perform processing of step S14 instead of steps S4 and S5 (see FIG. 4). For example, in step S14, the computation modules 23-0 to 23-n perform a computation shown in following Equation 4 using a predetermined weight greater than 0 but less than 1.

Ave[Count]×(1−weight)+ΔRV1×(weight) (Equation 4)

In Equation 4, “Ave[Count]” represents a resulting value previously calculated as average value “Ave[Count]” and “ΔRV1” represents the amplified rotation component ΔRV1 (value based on the rotation component) received from the third amplification module 25. Then, the computation modules 23-0 to 23-n additionally input the computation result by Equation 4 in the average value “Ave[Count]” and updates the average value “Ave[Count].”

### Second Embodiment

Next, a magnetic disk device 200 according to the second embodiment will be explained. In the following, different parts from the first embodiment will be mainly explained.

In the first embodiment, a learning value by the extraction module 21 is supplied as is to the second amplification module 27; however, in the second embodiment, the learning value by the extraction module 21 is passed through a filter 229 before being supplied to the second amplification module 27 to remove radio frequency noise.

To be more specific, an internal configuration of the acceleration feedforward module 220 in the magnetic disk device 200 is different from that of the first embodiment. The acceleration feedforward module 220 further has the filter 229. For example, the filter 229 is arranged between the extraction module 21 and the second amplification module 27. For example, the filter 229 has an FIR-type (Finite Impulse Response) filter 229a and removes radio frequency components higher than frequencies that are based on the rotation signals SPM-0 to SPM-n of the spindle motor 6, from the rotation synchronization components RRO-0 to RRO-n extracted by the extraction module 21. The filter 229 supplies the rotation synchronization components RRO-0 to RRO-n that has been subjected to removal processing to the second amplification module 27 (e.g. variable gain amplifier 27a).

Thus, according to the second embodiment, it is possible to remove radio frequency components higher than frequencies that are based on the rotation signals SPM-0 to SPM-n of the spindle motor 6, from the rotation synchronization components RRO-0 to RRO-n before being amplified by the second amplification module 27, as radio frequency noise. By this means, it is possible to prevent radio frequency noise from being amplified and suppress an influence due to the radio frequency, noise included in the rotation synchronization components RRO-0 to RRO-n.

### Third Embodiment

Next, a magnetic disk device 300 according to the third embodiment will be explained. In the following, different parts from the first embodiment will be mainly explained.

In the first embodiment, amplification processing on the rotation component ΔRV received from the acquisition module 10 for the extraction module 21 and the first amplification module 26 is commonly performed in the third amplification module 25; however, in the third embodiment, amplification processing on the rotation component ΔRV received from the acquisition module 10 is separately performed for the extraction module 21 and the first amplification module 26.

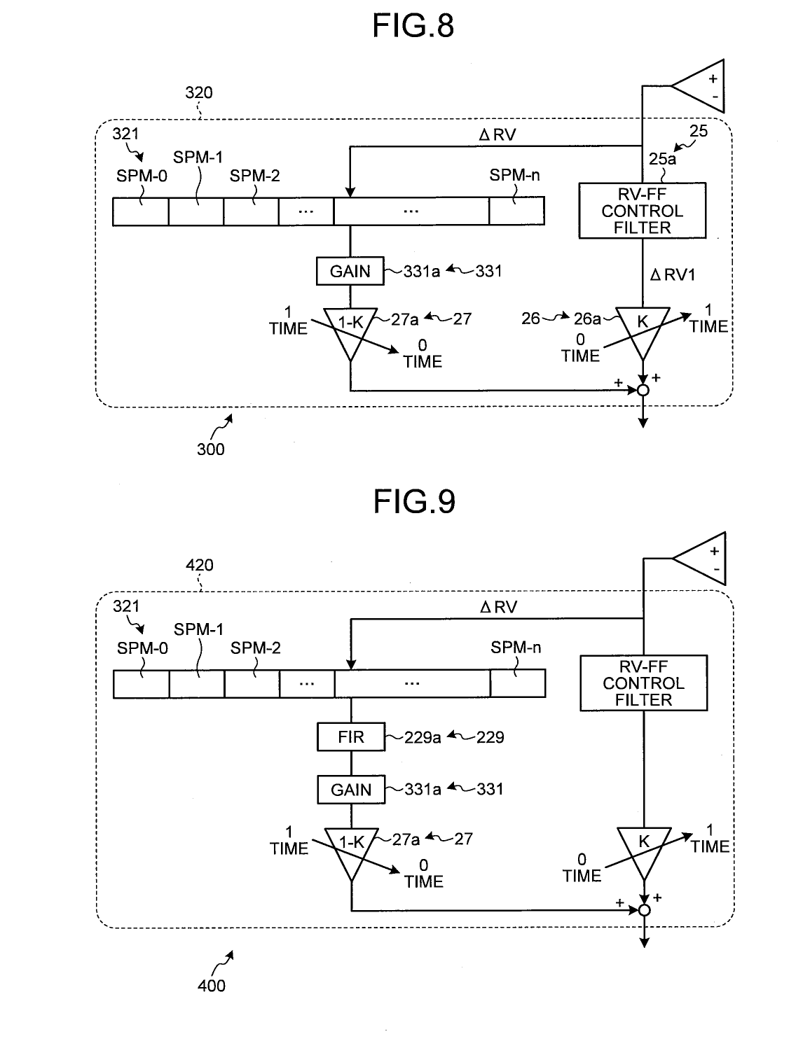

That is, as shown in FIG. 8, regarding learning by an extraction module 321, an output of the third amplification module 25 (e.g. control filter 25a) is not regarded as an input, but derivation from an input of the third amplification module 25 is acceptable. At this time, the third amplification module 25 is not passed through, and therefore it is necessary to apply an equivalent gain in a fourth amplification module 331.

To be more specific, an internal configuration of an acceleration feedforward module 320 in the magnetic disk device 300 is different from that of the first embodiment. The extraction module 321 of the acceleration feedforward module 320 receives the rotation component ΔRV from the acquisition module 10 and extracts the rotation synchronization component RRO from the rotation component ΔRV.

Also, the acceleration feedforward module 320 further has the fourth amplification module 331. For example, the fourth amplification module 331 is arranged between the extraction module 321 and the second amplification module 27. For example, the fourth amplification module 331 has a gain amplifier 331a in which gain G equivalent to that of the control filter 25a is set, and amplifies the rotation synchronization components RRO-0 to RRO-n extracted by the extraction module 321 by the gain G. The fourth amplification module 331 supplies the amplified rotation synchronization components RRO-0 to RRO-n to the second amplification module 27 (e.g. variable gain amplifier 27a).

Thus, according to the third embodiment, it is possible to perform amplification processing on the rotation component ΔRV received from the acquisition module 10, on the previous stage of the first amplification module 26 and the previous stage of the second amplification module 27 in parallel, so that it is possible to speed up the entire acceleration feedforward processing by the acceleration feedforward module 320.

### Fourth Embodiment

Next, a magnetic disk device 400 according to the fourth embodiment will be explained. In the following, different parts from the third embodiment will be mainly explained.

In the third embodiment, a learning value by the extraction module 321 is supplied as is to the fourth amplification module 331; however, in the fourth embodiment, a learning value by the extraction module 321 is passed through the filter 229 before being supplied to the fourth amplification module 331 to remove radio frequency noise.

To be more specific, an internal configuration of an acceleration feedforward module 420 in the magnetic disk device 400 is different from that of the third embodiment. The acceleration feedforward module 420 further has the filter 229. For example, the filter 229 is arranged between the extraction module 321 and the fourth amplification module 331. For example, the filter 229 has the FIR-type (Finite Impulse Response) filter 229a and removes radio frequency components higher than frequencies that are based on the rotation signals SPM-0 to SPM-n of the spindle motor 6, from the rotation synchronization components RRO-0 to RRO-n extracted by the extraction module 321. The filter 229 supplies the rotation synchronization components RRO-0 to RRO-n that has been subjected to removal processing to the forth amplification module 331 (e.g. variable gain amplifier 331a).

Thus, according to the fourth embodiment, it is possible to remove radio frequency components higher than frequencies that are based on the rotation signals SPM-0 to SPM-n of the spindle motor 6, from the rotation synchronization components RRO-0 to RRO-n before being amplified by the fourth amplification module 331 and the second amplification module 27, as radio frequency noise. By this means, it is possible to prevent radio frequency noise from being amplified and suppress an influence due to the radio frequency noise included in the rotation synchronization components RRO-0 to RRO-n.

### Fifth Embodiment

Next, a magnetic disk device 500 according to the fifth embodiment will be explained. In the following, different parts from the first embodiment will be mainly explained.

In the first embodiment, the extraction module 21 has the multiple storage modules 24-0 to 24-n corresponding to the multiple rotation signals SPM-0 to SPM-n of the spindle motor 6; however, in this method, there is a case where a memory is insufficient or heavy. Therefore, according to the fifth embodiment, learning by an extraction module 521 is performed by a DFT (Discrete Fourier Transform) computation which selectively extracts frequencies with high vibration components.

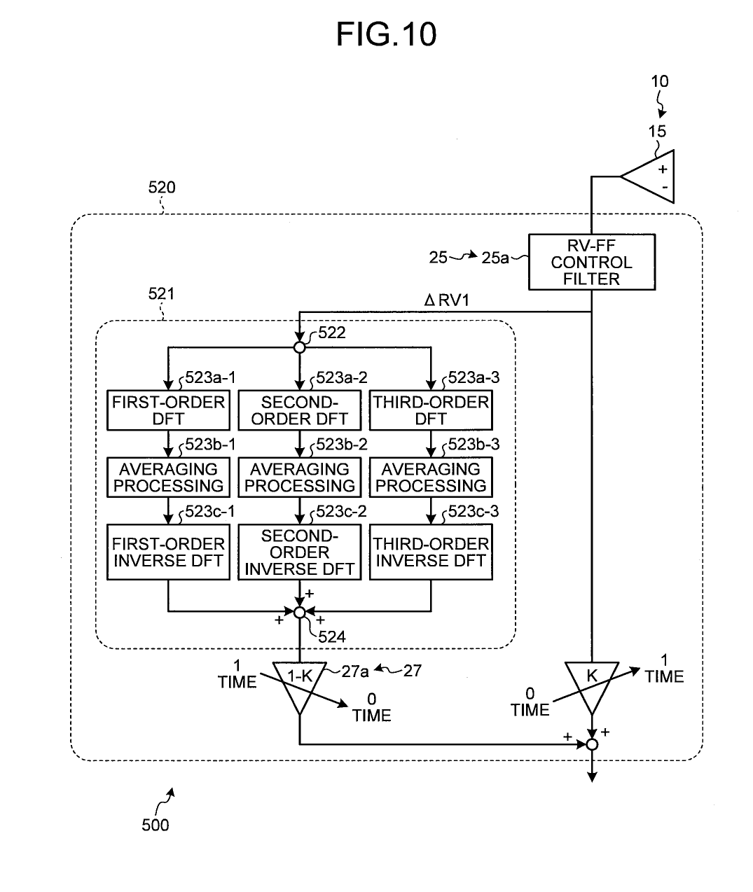

That is, as shown in FIG. 10, from an input on the time axis, X-order DFT that is X times (e.g. X=1, 2 or 3) of the rotation period is applied to calculate an amplitude and a phase and calculate an average value. From the average amplitude and phase, inverse DFT is performed to provide an output value on the time axis. Here, the first order shows rotation components of one period by one revolution, the second order shows rotation components of two periods by one revolution, and the third order shows rotation components of three periods by one revolution.

To be more specific, as shown in FIG. 10, an internal configuration of an acceleration feedforward module 520 in the magnetic disk device 500 is different from that of the first embodiment. The acceleration feedforward module 520 has an extraction module 521 instead of the extraction module 21 (see FIG. 1).

The extraction module 521 has a distributor 522, transform modules 523a-1 to 523a-3, processing modules 523b-1 to 523b-3, inverse transform modules 523c-1 to 523c-3 and a compositor 524. The distributor 522 receives the amplified rotation component ΔRV1 from the third amplification module 25 and distributes it to the multiple transform modules 523a-1 to 523a-3.

The transform module 523a-1 receives the amplified rotation component ΔRV1 from the distributor 522, performs first-order discrete Fourier transform of this rotation component ΔRV1 and obtains a component synchronized with the rotation signal SPM-0 of the spindle motor. The transform module 523a-1 supplies the obtained component to the processing module 523b-1.

The transform module 523a-2 receives the amplified rotation component ΔRV1 from the distributor 522, performs second-order discrete Fourier transform of this rotation component ΔRV1 and obtains a component synchronized with the rotation signal SPM-1 of the spindle motor. The transform module 523a-2 supplies the obtained component to the processing module 523b-2.

The transform module 523a-3 receives the amplified rotation, component ΔRV1 from the distributor 522, performs third-order discrete Fourier transform of this rotation component ΔRV1 and obtains a component synchronized with the rotation signal SPM-2 of the spindle motor. The transform module 523a-3 supplies the obtained component to the processing module 523b-3.

The processing module 523b-1 receives the component that has been subjected to first-order discrete Fourier transform from the transform module 523a-1 and averages the received component to obtain an average value. The processing module 523b-1 supplies the obtained average value to the inverse transform module 523c-1.

The processing module 523b-2 receives the component that has been subjected to second-order discrete Fourier transform from the transform module 523a-2 and averages the received component to obtain an average value. The processing module 523b-2 supplies the obtained average value to the inverse transform module 523c-2.

The processing module 523b-3 receives the component that has been subjected to third-order discrete Fourier transform from the transform module 523a-3 and averages the received component to obtain an average value. The processing module 523b-3 supplies the obtained average value to the inverse transform module 523c-3.

The inverse transform module 523c-1 receives the averaged average value that has been subjected to first-order discrete Fourier transform from the processing module 523b-1 and performs first-order inverse discrete Fourier transform on the received average value to obtain, for example, a first-order rotation synchronization component. The inverse transform module 523c-1 supplies the obtained first-order rotation synchronization component to the compositor 524.

The inverse transform module 523c-2 receives the averaged average value that has been subjected to second-order discrete Fourier transform from the processing module 523b-2 and performs second-order inverse discrete Fourier transform on the received average value to obtain, for example, a second-order rotation synchronization component. The inverse transform module 523c-2 supplies the obtained second-order rotation synchronization component to the compositor 524.

The inverse transform module 523c-3 receives the averaged average value that has been subjected to third-order discrete Fourier transform from the processing module 523b-3 and performs third-order inverse discrete Fourier transform on the received average value to obtain, for example, a third-order rotation synchronization component. The inverse transform module 523c-3 supplies the obtained third-order rotation synchronization component to the compositor 524.

The compositor 524 receives the first-order rotation synchronization component from the inverse transform module 523c-1, receives the second-order rotation synchronization component from the inverse transform module 523c-2 and receives the third-order rotation synchronization component from the inverse transform module 523c-3. For example, the compositor 524 combines the first-order rotation synchronization component, the second-order rotation synchronization component and the third-order rotation synchronization component RRO to supply to the second amplification module 27.

Thus, according to the fifth embodiment, it is possible to selectively extract frequencies with high vibration components to obtain the rotation synchronization component RRO, so that it is possible to reduce a memory required for learning and speed up learning processing.

### Sixth Embodiment

Next, a magnetic disk device 600 according to the sixth embodiment will be explained. In the following, different parts from the fifth embodiment will be mainly explained.

In the fifth embodiment, amplification processing on the rotation component ΔRV received from the acquisition module 10 for the extraction module 521 and the first amplification module 26 is commonly performed in the third amplification module 25; however, in the sixth embodiment, amplification processing on the rotation component ΔRV received from the acquisition module 10 is separately performed for the extraction module 521 and the first amplification module 26.

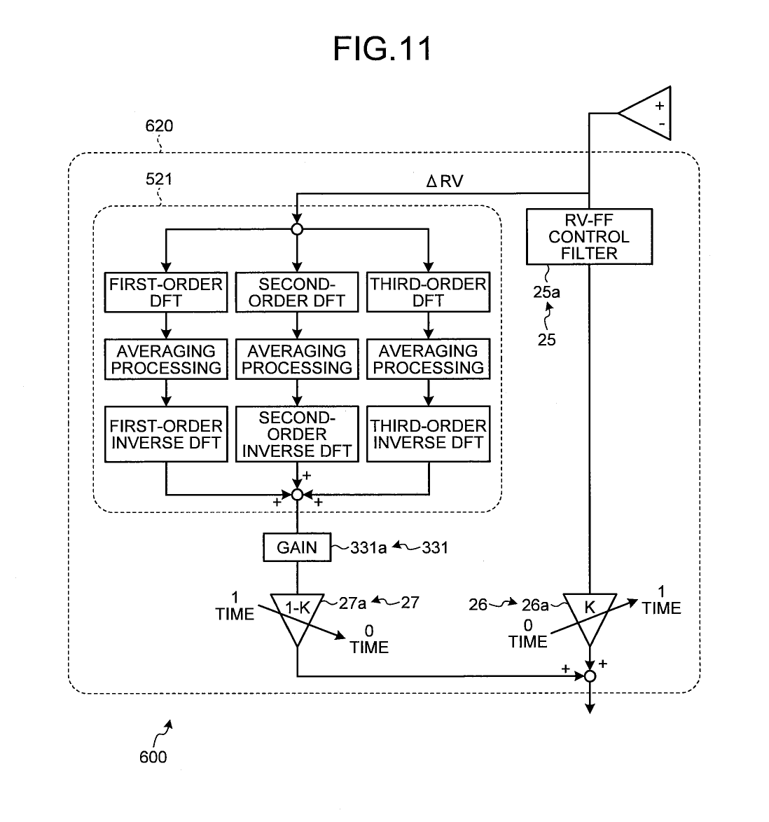

That is, as shown in FIG. 11, regarding learning by the extraction module 521, an output of the third amplification module 25 (e.g. control filter 25a) is not regarded as an input, but derivation from an input of the third amplification module 25 is acceptable. At this time, the third amplification module 25 is not passed through, and therefore it is necessary to apply an equivalent gain in the fourth amplification module 331.

To be more specific, an internal configuration of an acceleration feedforward module 620 in the magnetic disk device 600 is different from that of the fifth embodiment. The extraction module 521 of the acceleration feedforward module 620 receives the rotation component ΔRV from the acquisition module 10 and extracts the rotation synchronization component RRO from the rotation component ΔRV.

Also, the acceleration feedforward module 620 further has the fourth amplification module 331. For example, the fourth amplification module 331 is arranged between the extraction module 521 and the second amplification module 27. For example, the fourth amplification module 331 has the gain amplifier 331a in which the gain G equivalent to that of the control filter 25a is set, and amplifies the rotation synchronization component RRO extracted by the extraction module 521 by the gain G. The fourth amplification module 331 supplies the amplified rotation synchronization component RRO to the second amplification module 27 (e.g. variable gain amplifier 27a).

Thus, according to the sixth embodiment, it is possible to perform amplification processing on the rotation component ΔRV received from the acquisition module 10, on the previous stage of the first amplification module 26 and the previous stage of the second amplification module 27 in parallel, so that it is possible to speed up the entire acceleration feedforward processing by the acceleration feedforward module 620.

### Seventh Embodiment

Next, a magnetic disk device 700 according to the seventh embodiment will be explained. In the following, different parts from the first embodiment will be mainly explained.

According to the first embodiment, the first gain K of the first amplification module 26 and the second gain 1−K of the second amplification module 27 are controlled by the external controller (not shown); however, in the seventh embodiment, the first gain K of the first amplification module 26 and the second gain 1−K of the second amplification module 27 are controlled in an acceleration feedforward module 720.

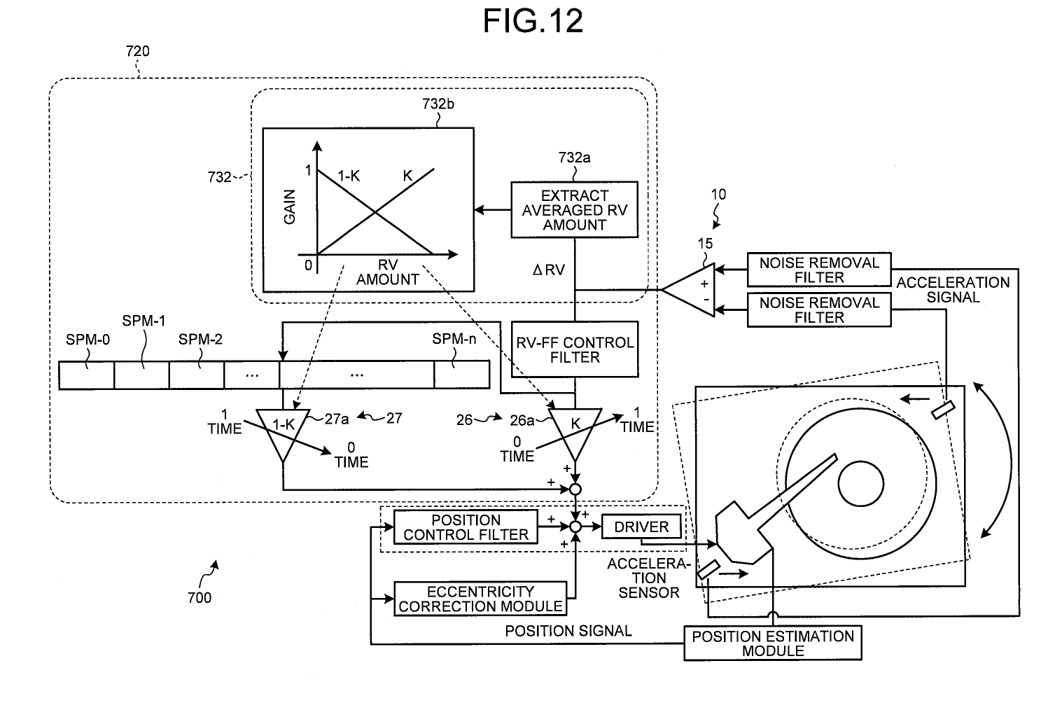

To be more specific, as shown in FIG. 12, the acceleration feedforward module 720 in the magnetic disk device 700 further has a determination module 732. The determination module 732 determines the first gain K and the second gain 1−K according to the rotation component ΔRV acquired by the acquisition module 10. For example, the determination module 732 has an averaging processing module 732a and a determination processing module 732b.

The averaging processing module 732a receives the rotation component ΔRV from the acquisition module 10 and averages the rotation component ΔRV. The averaging processing module 732a supplies the averaged rotation component ΔRVm to the determination processing module 732b.

The determination processing module 732b determines the first gain K and the second gain 1−K from the averaged rotation component ΔRVm. Also, the determination processing module 732b may have control information as shown in FIG. 2. In the control information shown in FIG. 2, it is determined in advance for each value of the rotation component ΔRVm (RV amount) that a sum of the first gain K of the first amplification module 26 and the second gain 1−K of the second amplification module 27 is 1. For example, when the determination processing module 732b receives the rotation component ΔRVm from the averaging processing module 732a, the determination processing module 732b refers to the control information shown in FIG. 2 and determines the first gain K and the second gain 1−K corresponding to a value of the received rotation component ΔRVm (RV amount).

At this time, the determination processing module 732b may determine the first gain K and the second gain 1−K according to change amount ACH (=ΔRVm1−ΔRVm2) between value ΔRVm1 of the rotation component ΔRVm at the time of previously determining the first gain K and the second gain 1−K and value ΔRVm2 of the current rotation component ΔRVm. For example, when the determination processing module 732b receives the rotation component ΔRVm from the averaging processing module 732a, the determination processing module 732b obtains the change amount ACH between the value ΔRVm1 of the rotation component ΔRVm at the time of previously determining the first gain K and the second gain 1−K and the value ΔRVm2 of the current rotation component ΔRVm. Then, the determination processing module 732b compares the change amount ACH and predetermined threshold TH. If the change amount ACH is less than the threshold TH, the determination processing module 732b maintains the first gain K and the second gain 1−K previously determined, and, if the change amount ACH is equal to or greater than the threshold TH, the determination processing module 732b changes and determines the first gain K and the second gain 1−K. Then, the determination processing module 732b supplies a control signal based on the determination result to the first amplification module 26 and the second amplification module 27.

Thus, according to the seventh embodiment, the first gain K of the first amplification module 26 and the second gain 1−K of the second amplification module 27 are controlled in the acceleration feedforward module 720, so that it is possible to respond to a change in acceleration acting on the case 1 at higher speed compared to a case where the first gain K and the second gain 1−K are controlled by the external controller.

Also, according to the seventh embodiment, the determination module 732 determines the first gain K and the second gain 1−K according to the change amount ACH between the rotation component at the time of previously determining the first gain K and the second gain 1−K and the current rotation component. That is, if the change amount ACH is less than the threshold TH, the determination module 732 maintains the first gain K and the second gain 1−K previously determined, and, if the change amount ACH is equal to or greater than the threshold TH, the determination module 732 changes and determines the first gain K and the second gain 1−K. By this means, it is possible to prevent the first gain K of the first amplification module 26 and the second gain 1−K of the second amplification module 27 from being often changed, and to stably control the first gain K of the first amplification module 26 and the second gain 1−K of the second amplification module 27.

Also, according to the seventh embodiment, the determination module 732 averages the rotation component ΔRV acquired by the acquisition module 10 and determines the first gain K and the second gain 1−K from the averaged rotation component ΔRVm. By this means, it is possible to extract the rotation component ΔRVm corresponding to rotation synchronization components included in the rotation component ΔRV and determine the first gain K and the second gain 1−K from the rotation component ΔRVm corresponding to the rotation synchronization components, so that it is possible to improve control accuracy of the first gain K of the first amplification module 26 and the second gain 1−K of the second amplification module 27.

Here, if there is a specific frequency resonance in a system or the like, instead of averaging the rotation component ΔRV in the averaging processing module 732a, a component of the specific frequency may be extracted by discrete Fourier transform.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
an acceleration feedforward module configured to obtain a first correction amount to correct a rotation vibration of a case, based on a rotation component of an acceleration acting on the case;
an eccentricity correction module configured to obtain a second correction amount to perform an eccentricity correction of a magnetic disk, based on a position of a magnetic head with respect to the magnetic disk; and
a control module configured to perform control of a position of the magnetic head using the first correction amount and the second correction amount,
wherein the acceleration feedforward module comprises:
a first amplification module configured to amplify a first rotation correlation value according to the rotation component by a first gain;
a second amplification module configured to amplify a second rotation correlation value according to a rotation synchronization component of the rotation component, by a second gain acquired by subtracting the first gain from one; and
an addition module configured to add the first rotation correlation value amplified by the first amplification module and the second rotation correlation value amplified by the second amplification module to obtain the first correction amount.

2. The magnetic disk device according to claim 1, wherein the first gain is a value equal to or greater than zero but equal to or less than one.

3. The magnetic disk device according to claim 2, further comprising an acquisition module configured to acquire the rotation component of the acceleration acting on the case, wherein:
the acceleration feedforward module further comprises an extraction module configured to extract the rotation synchronization component from a value according to the rotation component acquired by the acquisition module; and
the second amplification module is configured to amplify the rotation synchronization component extracted by the extraction module by the second gain.

4. The magnetic disk device according to claim 3, wherein the acquisition module comprises:
a plurality of acceleration sensors configured to detect accelerations acting on the case; and
a differentiator configured to obtain a difference between the accelerations detected by the plurality of acceleration sensors, as the rotation component.

5. The magnetic disk device according to claim 3, wherein the extraction module is configured to average a value according to a plurality of rotation components acquired over multiple times by the acquisition module, to obtain a component synchronized with a rotation signal of a spindle motor, to learn the obtained component and to extract the rotation synchronization component.

6. The magnetic disk device according to claim 3, wherein:
the extraction module is configured to receive the rotation component output from the acquisition module, as a value according to the rotation component; and
the acceleration feedforward module comprises:
a third amplification module configured to amplify the rotation component by a third gain and output the amplified rotation component to the first amplification module as the first rotation correlation value; and
a fourth amplification module configured to amplify the rotation synchronization component extracted by the extraction module by the third gain and to output to the second amplification module.

7. The magnetic disk device according to claim 3, wherein the acceleration feedforward module further comprises a filter configured to remove a frequency component higher than a frequency according to a rotation signal of a spindle motor, from the rotation synchronization component extracted by the extraction module.

8. The magnetic disk device according to claim 3, wherein the extraction module further comprises:
a transform module configured to perform a discrete Fourier transform on the rotation component to obtain a component synchronized with a rotation signal of a spindle motor;
a processing module configured to average the component obtained by the transform module to obtain an average value; and
an inverse transform module configured to perform an inverse discrete Fourier transform on the average value obtained by the processing module to obtain the rotation synchronization component.

9. The magnetic disk device according to claim 1, further comprising an acquisition module configured to acquire the rotation component of the acceleration acting on the case, wherein:
the acceleration feedforward module further comprises a determination module configured to determine the first gain and the second gain according to the rotation component acquired by the acquisition module; and wherein
the first amplification module is configured to amplify the first rotation correlation value by the first gain determined by the determination module; and
the second amplification module is configured to amplify the second rotation correlation value by the second gain determined by the determination module.

10. A method for controlling a magnetic disk device having a case, a magnetic disk and a magnetic head, the method comprising:
obtaining a first correction amount to correct a rotation vibration of the case, based on a rotation component of an acceleration acting on the case;
obtaining a second correction amount to perform an eccentricity correction of the magnetic disk, based on a position of the magnetic head with respect to the magnetic disk; and
performing control of a position of the magnetic head using the first correction amount and the second correction amount,
wherein obtaining the first correction amount comprises:
amplifying a first rotation correlation value according to the rotation component by a first gain;
amplifying a second rotation correlation value according to a rotation synchronization component of the rotation component, by a second gain acquired by subtracting the first gain from 1; and
adding the first rotation correlation value amplified and the second rotation correlation value amplified to obtain the first correction amount.

11. The method according to claim 10, wherein the first gain is a value equal to or greater than zero but equal to or less than one.

12. The method according to claim 11, further comprising acquiring the rotation component of the acceleration acting on the case, wherein:
the obtaining the first correction amount comprises extracting the rotation synchronization component from a value according to the rotation component acquired by the acquiring; and
the amplifying a second rotation correlation value is configured to amplify the rotation synchronization component extracted by the extracting by the second gain.

13. The method according to claim 12, wherein the acquiring comprises:
detecting accelerations acting on the case, by a plurality of acceleration sensors; and
obtaining a difference between the accelerations detected by the plurality of acceleration sensors, as the rotation component, by a differentiator.

14. The method according to claim 12, wherein the extracting is configured to average a value according to a plurality of rotation components acquired over multiple times by the acquiring, to obtain a component synchronized with a rotation signal of a spindle motor, to learn the obtained component, and to extract the rotation synchronization component.

15. The method according to claim 12, wherein:
the extracting is configured to receive the rotation component output from the acquiring, as a value according to the rotation component; and
the obtaining the first correction amount comprises:
amplifying the rotation component by a third gain and outputting the amplified rotation component as the first rotation correlation value; and
amplifying the rotation synchronization component extracted by the extracting by the third gain and outputting.

16. The method according to claim 12, wherein the obtaining a first correction amount further comprises removing a frequency component higher than a frequency according to a rotation signal of a spindle motor, from the rotation synchronization component extracted by the extracting.

17. The method according to claim 12, wherein the extracting further comprises:
performing a discrete Fourier transform on the rotation component to obtain a component synchronized with a rotation signal of a spindle motor;
averaging the component obtained by the performing the discrete Fourier transform to obtain an average value; and
performing an inverse discrete Fourier transform on the average value obtained by the averaging to obtain the rotation synchronization component.

18. The method according to claim 10, further comprising acquiring the rotation component of the acceleration acting on the case, wherein:
the obtaining the first correction amount comprises determining the first gain and the second gain according to the rotation component acquired by the acquiring;
the amplifying the first rotation correlation is configured to amplify the first rotation correlation value by the first gain determined by the determining; and
the amplifying the second rotation correlation value is configured to amplify the second rotation correlation value by the second gain determined by the determining.
